(19) United States
(12) Patent Application Publication
(10) Pub. No.: US 2007/0184878 A1
(43) Pub. Date: Aug. 9, 2007

(54) TEXT INPUTTING

(75) Inventor: Sung-Bum Lee, Gyeonggi-Do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 11/671,337

(22) Filed: Feb. 5, 2007

(30) Foreign Application Priority Data
Feb. 3, 2006 (KR) 10-2006-0010861

(51) Int. Cl. H04B 1/38

(52) U.S. Cl. 455/565

(57) ABSTRACT

More convenient text inputting can be achieved by receiving text entries from a user via a keypad in a particular text input mode, activating a different text input mode via a text input mode converter operated by the user, and receiving text entries from the user via the keypad in the different text input mode while the text input mode converter is being depressed or continuously touched by the user.

### BACKGROUND

The present disclosure relates to text inputting.

In general, a mobile communication terminal may support features associated with communication functions, such as a wireless Internet access services, text (multimedia) messaging, and wireless on-line game services. Also, a mobile communication terminal may provide additional functions unrelated to communication functions, such as image or video capturing, taking memos, performing schedule or calendar management, alarm functions, and the like.

When the user wants perform text messaging (by inputting characters, symbols, numbers, etc.) or wishes to input text entries into a phone/address book or the like, the user should press many function keys (or select many menu items or options) in order to change the current text input mode to a desired text input mode.

For example, while entering a particular type of text (such as lower case alphabet letters), if another type of text (e.g., upper case letters, numbers, symbols, special characters, etc.) should be entered, the user must change the current text input mode (e.g., lower case input mode) to the desired text input mode (e.g., upper case input mode, number input mode, special character input mode, etc.) by manipulating multiple buttons and/or by selecting various menu items. Thereafter, when the user wants to return to the previous text input mode (i.e., back to lower case alphabet letters), the user must manipulate and/or select various buttons or menu items again.

FIG. 1 is a flow chart illustrating the processes of an exemplary method for inputting text characters.

As shown in FIG. 1, when the user wants to input a certain type of text (English alphabet letters, numbers, characters, etc.), a desired text input mode is selected (S100). For example, after selecting an English text input mode (S102), when a lower case input mode (for alphabet letter entries) is selected, the user may enter lower case alphabet text (S104→S106). When an upper case input mode is selected, the user can then enter the desired upper case alphabet text (S104→S108).

Then, when the user wants to convert from the upper case input mode to the lower case input mode (or vice versa) or select a different input mode, the user should manipulate a plurality of keys (and/or use menu selection options) to change (convert) the text input mode (S106, S108, S110).

If a number input mode is selected (S100→S102→S112 or via S110), the user can select a number entry option for entering numbers (S114→S116) or a symbol entry option for entering symbols (S114→S118). Then, when the user wants to convert from the number input mode to the symbol input mode (or vice versa) or select a new input mode, the user should manipulate a plurality of keys (and/or use menu selection options) to change (convert) to the desired input mode (S116, S118, S120).

When text inputting (e.g., characters, numbers, symbols, etc.) is completed (S102˜S120), then the text input mode may be terminated (S122).

The above-described text inputting (entering) method has some drawbacks. For example, when the user wants to change from a current text input mode to a different text input mode, the user must pause his text entry operation, and press a plurality of keys (and/or go through various menu options) to change (convert) to the desired text input mode. However, this is inconvenient and time consuming.

Also, in such text entering method that requires the pressing and releasing of a sequence of individual keys (or buttons), a subsequent key entry (input) cannot be recognized until the previously pressed key is completely released. Thus, in order to change (convert) from one text input mode to another text input mode (e.g., changing between upper case and lower case letters of the English alphabet, changing between single and double consonants of the Korean alphabet, changing between numbers and symbols, etc.) the user should press multiple keys one-by-one, which is inconvenient and time consuming.

Namely, the above-described text entering (inputting) method does not support a so-called multi-key input function that allows simultaneous inputting of two or more keys (or buttons) during text entry.

### SUMMARY

One aspect of this disclosure is that the present inventors recognized the above-described problems with certain text inputting (entering) methods. Based upon such recognition, the following features have been conceived.

An aspect of some exemplary embodiments described herein is to provide a method of inputting text (characters) for a mobile terminal (or the like) that allows more convenient changing (converting) between various types of text input modes. This is achieved by allowing the user to continuously depress (i.e., hold down) or continuously touch a text input changing (converting) mechanism while still allowing the user to enter text via a (virtual or non-virtual) keypad on the mobile terminal.

### BRIEF DESCRIPTION OF THE DRAWINGS

FIG. 1 is a flow chart illustrating the processes of an exemplary method for inputting (entering) text.

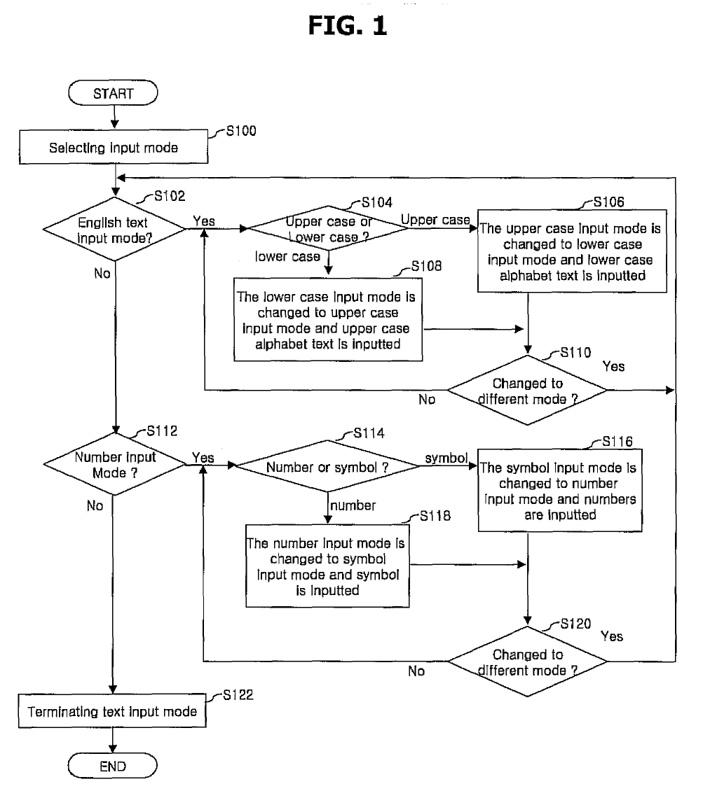

FIG. 2 is a schematic block diagram showing a text input unit of a terminal according to one exemplary embodiment.

FIG. 3 shows the exterior of the terminal according to one exemplary embodiment.

FIG. 4 is a rear view of the terminal according to one exemplary 1o embodiment.

FIG. 5 is a flow chart illustrating the processes of a text input method according to one exemplary embodiment.

### DETAILED DESCRIPTION

This disclosure provides a text (or character) input apparatus and method of a mobile terminal that can change (convert) between various types of text input modes by allowing the user to continuously depress (i.e., hold down) or continuously touch a text input converting mechanism while allowing the user to enter (input) text via a (virtual or non-virtual) keypad on the mobile terminal.

Although this disclosure focuses on exemplary embodiments for a mobile terminal, it can be clearly understood that these features are applicable to various types of electronic devices, such as mobile (cell) phones, smart phones, PDAs, portable computing devices, wireless terminals, and the like.

A virtual keypad may refer to a graphical keypad that can be displayed on a screen of the mobile terminal and are activated by being touched. Such touch operation may be performed by using the user's finger(s), a stylus, or the like.

A non-virtual keypad may refer to a physical group of keys or buttons that exist on the mobile terminal and are activated by being pressed by the user.

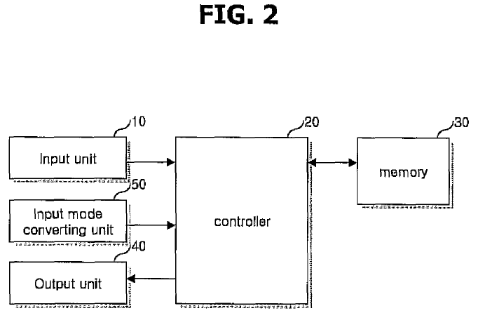

FIG. 2 is a schematic block diagram showing a text input unit of a mobile terminal according to an exemplary embodiment.

The mobile terminal may include an input unit 10 (e.g., a virtual or non-virtual keypad, etc.) for receiving text entries; an input mode converting unit 50 (e.g., a button mechanism, a touch-sensitive mechanism, etc.) operated by the user to change or convert a text input mode; a controller 20 (e.g., a microprocessor, control unit, etc.) for changing a text input function according to the user operation of the input mode converting unit 50; a memory 30 (e.g., a cache memory, a storage medium, etc.) for storing information; and an output unit 40 (e.g., a screen, an LCD, a flexible display unit, audio speakers, vibration unit, etc.) for providing outputs in at least one of a visual, audible and/or tactile manner according to the control of the controller 20.

The input mode converting unit 50 may be comprised of a text selector implemented as a button (or key) and/or a contact sensing unit (with an appropriate touch-activated surface) located at one or more desired portions of the mobile terminal and that can be activated by the user (upon pressing, pushing, touching, etc.) while allowing the user to simultaneously enter text via the (virtual or non-virtual) keypad.

The text selector can be implemented by using a key or button that already exists on the mobile terminal (e.g., directional keys, side buttons, send key, end key, delete key, etc.) or may be implemented as a separate or dedicated key or button (or touch-sensitive element).

As such, although many implementations are possible, the basic concept conceived by the present inventors is to provide a dedicated means (i.e., key, button, touch-sensitive element, etc.) that can be easily activated (and de-activated) by the user during text entry (inputting) without having to go through numerous menu options that would require a plurality of key (button) selections and operations to be performed by the user.

The user may change the text input (entry) mode by operating the text selector in a non-continuous or continuous manner. The non-continuous manner refers to momentarily pressing and then releasing the button or key of the text selector, while the continuous manner refers to continuously depressing or touching the touch surface element of the text selector.

Such non-continuous or continuous manner may be provided as a selectable option to the user, who may select the one that is more convenient for him. Also, one of these two options may be set as the default in the absence of any user selection.

The text selector may only need to be pressed (or touched) once in order to change to a different text entry mode. In addition, a plurality of text entry modes can be shown to the user and scrolled through with each pressing (or touching) of the text selector. When a desired text entry mode is found after scrolling, the user may activate the desired text entry mode. If the text selector is implemented as a touch-sensitive element, a finger swipe (or dragging) action detected thereon can be interpreted as a scroll operation that allows the user to scroll through various menu items.

Alternatively, the text selector may be set such that it would need to be continuously depressed or touched to activate and maintain activation of a different text entry mode, while releasing the depressed or touched text selector de-activates the different text entry mode. This may be comparable to a shift key function and operation that can be performed on a typical computer keyboard.

For example, while the user performs text entry in a first text entry mode, if the text selector is continuously depressed or continuously touched, a second text entry mode is activated to allow text entries in the second text entry mode. Thereafter, releasing the depressed or touched text selector allows returning to the first entry mode. In such manner, at least two different text entry modes can be easily activated and de-activated to thus allow more convenient text inputting. The desired at least two types of text entry modes can be specifically pre-selected by the user among multiple text entry modes. Alternatively, two different text entry modes may be the default based upon the language setting of the mobile terminal.

It can be understood that there can be many types of text entry modes, such as lower case letter, upper case letters, number, symbols, etc. are possible and these text entry modes may vary depending upon the particular characteristics of the language that the user wishes to use. As such, a plurality of text entry modes (and/or options) may be initially shown to the user, who may set his preferences as desired.

Additionally, there may be other keys, buttons or elements (e.g., menu selection buttons, thumb wheel, scroll wheel, scroll bar, touch-activated elements or surfaces, etc.) to allow additional user interface functions to be performed.

If the input mode converting unit 50 is implemented as a mechanical button or key, the physical pressing and later releasing thereof can be detected by using actuators or other means of implementation.

If the input mode converting unit 50 is implemented to be touch activated, the user's touch operation can be sensed and/or recognized by various means (such as by use of sensors, detectors, etc.) upon detecting changes on the surface of the contact sensing unit. Such detecting may be based upon at least one of the changes in resistance, capacitance, temperature, pressure, touch screen illumination, and the like, that are caused by the user's touch. Other types of touch-activation detection may also be used, such as proximity sensing or the like.

Upon detecting the user's pressing, touching, releasing, or the like, the input mode converting unit 50 may generate one or more signals or commands (to be sent to the controller 20) for changing a text input mode.

The controller 20 may receive and analyze the signals (or commands) that are generated when a key or touch element is pressed (touched) and later released. The controller 20 may cooperate with the memory 30 to store and/or retrieve appropriate information and data therein. Even when at least one key (or button) on the input unit 10 (e.g., a keypad with alphanumeric buttons) and the input mode converting unit 50 are pressed (or touched) simultaneously, the controller 20 can distinguish such simultaneous user inputs. Namely, the controller 20 can recognize which keys (or touch elements) have been selected, which keys are in a pressed state or which keys have been released.

An exemplary operation of the text input apparatus according to the present disclosure is described below with reference to FIGS. 2 through 4.

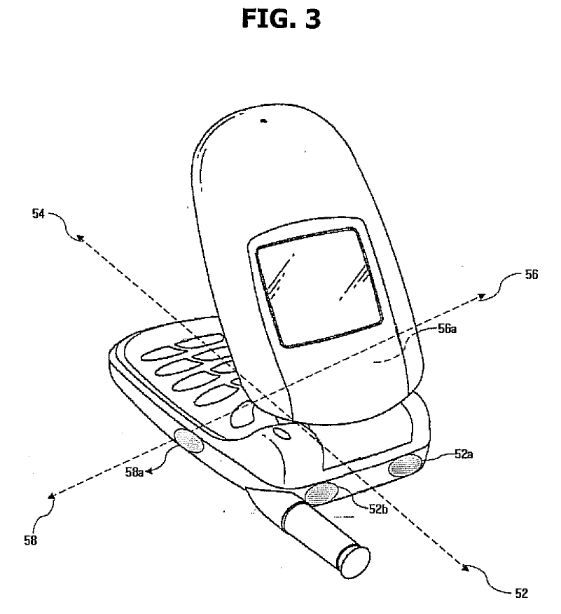

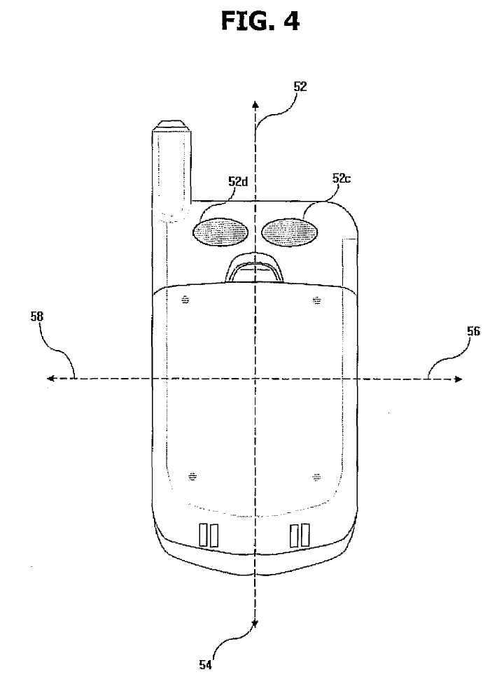

The input mode converting unit 50 may be implemented to be located at various places on the mobile terminal, as can be seen in exemplary FIGS. 3 and 4. For example, the input mode converting unit 50 may employ a plurality of contact sensing parts, such as 52a, 52b, 52c, 52d, 56a and 58a. However, it can be clearly understood that the particular number of contact sensing parts may be varied appropriately.

Certain configurations may be more convenient for right-handed users, while some configurations are better suited for left-handed users. Also, the particular shapes and sizes of each of the one or more contact sensing parts may be varied. Although each contact sensing part in FIGS. 3 and 4 is shown to be roughly oval in shape, other configurations are surely possible.

For example, there may be one or more contact sensing parts that are in the form of an elongated strip placed along an edge(s) of the mobile terminal. Also, the contact sensing part may be flush with the body of the mobile terminal or alternatively, the contact sensing part may be placed in a groove or indent portion, which may minimize unintended touching or contacting thereof.

To explain the operation of changing the text input mode, it is assumed that the user selects a text message composing option. However, it can be understood that the following operation can be implemented for any other type of text input operation besides text messaging.

If the user wishes to input text using English alphabet entries (i.e., upper case or lower case letters), the appropriate menu selection thereof via the input unit 10 may be performed. The controller 20 may then activate the text messaging function to thus display a window (or a screen region) to allow the user to view and enter a text message on a display or screen of the output unit 40.

When the user begins to perform text inputting, the entered text is displayed on the display screen and also stored in the memory 30 (such as a cache memory). It is assumed that English lower case entries are the default setting, while activating the text selector (of the input mode converting unit 50) allows for English upper case entries.

While inputting lower case letters, if the user activates the input mode converting unit 50 by pressing a certain key (e.g., the direction key, the side key or buttons) and then uses the keypad while depressing or touching one of the contact sensing parts 52a, 52b, 52c, 52d, 56a and 58a, the controller 20 reads these user inputs and determines that English upper case entries are to be made. As such, the user can enter upper case letters, which are shown on the display unit 40 and optionally also stored in the memory 30.

The controller 20 has a function of analyzing a signal generated when a key is pressed or released, and transmitting it to the memory 30 so as to be stored therein. Even when several keys are simultaneously pressed, the controller 20 can analyze and control key values by discriminating each key according to a press event or a release event. Namely, the controller 20 can recognize which keys have been pressed, which keys are in a pressed state or which keys have been released.

The input mode converting unit 50 can be implemented as a sub-keypad (e.g., the direction key, the side key, the send key, the end key or the delete key, etc.). Alternatively, a side function key (e.g., a key used for navigating or performing up/down user selection) located at the side of the terminal, or a button or contact sensing unit placed at an optimum location of the terminal at which the user can perform text inputting may be used.

In this manner, when the text selector (input mode converting unit 50) and the alphanumeric keys are pressed in the English input mode, it is recognized as English upper case letters. The lower case and the upper case letters may be printed on the keys of the keypad.

However, the features of the present disclosure can be implemented for different languages for various countries. For example, for the Korean language, the present features can be applied for conversion between single and double vowels or between single and double consonants.

FIG. 3 shows the exterior of the terminal according to one exemplary embodiment.

As shown in FIG. 3, when the terminal may be divided into an upper portion 52, a lower portion 54, a left portion 56 and a right portion 58. The input mode converting unit 50 may include buttons (keys) or contact sensing parts 52a, 52b, 52c, 52d, 56a and 58a which are placed at optimum locations that allow easy text inputting. Specifically, the upper left contact sensing part 52a may be positioned at the upper portion 52 of the terminal and can be touched by the user's left index finger. The upper right contact sensing part 52b may be positioned at the upper portion 52 of the terminal and can be touched by the user's right index finger. The left contact sensing part 56a may be positioned at the left portion 56 of the terminal. The right contact sensing part 58a may be positioned at the right portion 58 of the terminal. Thus, the input mode converting unit 50 can be provided at one or more locations according to user convenience.

FIG. 4 is a rear view of the terminal according to one exemplary embodiment.

As shown in FIG. 4, the input mode converting unit 50 may include a rear left contact sensing part 52c positioned at an upper portion 52 of the rear surface of the terminal and can be touched by the user's left index finger and a rear right contact sensing unit 52d may be positioned at the upper portion 52 of the rear surface of the terminal and can be touched by the user's right index finger.

For example, when an upper case letter is desired to be inputted in a lower case input mode, one (e.g., 52a, 52c and 56a) of the contact sensing parts 52a, 52b, 52c, 52d, 56a and 58a can be pressed and a lower case letter button can be pressed. Then, the inputted character is recognized as an upper case letter and the corresponding upper case letter is displayed on the display unit. Conversely, when a lower case letter is desired to be inputted in the upper case input mode, one (e.g., 52b, 52d and 58a) of the contact sensing parts 52a, 52b, 52c, 52d, 56a and 58a can be touched (pressed) and an upper case letter button can be pressed. Then, the inputted character is recognized as a lower case and the corresponding lower case is displayed on the display unit.

The reason of availability of the conversion of the lower case input mode and the upper case input mode is because lower cases and upper cases are displayed together on corresponding key buttons of the keypad of the terminal. In addition, as well as the conversion of the lower case and upper case input mode, in a country where single and double consonants are used, the single consonant and the double consonants can be converted and also numbers and symbols can be converted by using one of the contact sensing parts 52a, 52b, 52c, 52d, 56a and 58a.

In addition, mutual conversion between the English character mode, the number mode or a home country character input mode can be possible by pressing two of the contact sensing parts 52a, 52b, 52c, 52d, 56a and 58a. The contact sensing parts used for the conversion of the English, numbers and symbols and the mutual conversion can be set to user's taste and a particular function frequently used by the user can be set to be executed.

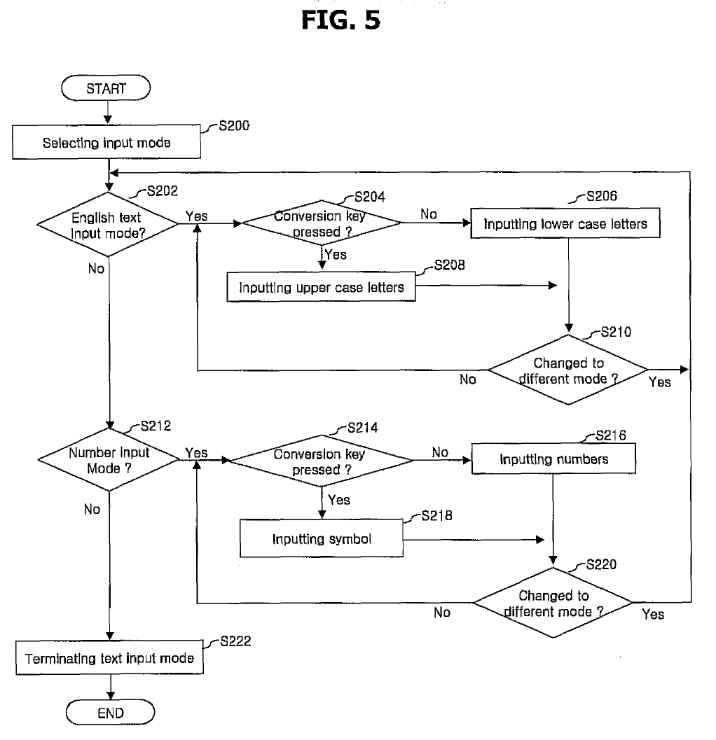

FIG. 5 is a flow chart illustrating the processes of character input method according to one exemplary embodiment.

First, it is assumed that characters, English, numbers and symbols are displayed on the key buttons of the keypad of the terminal.

When a name of a person related to a phone number is desired to be inputted or a message is desired to be created, a corresponding menu is selected and then the language (English) to be inputted and an input mode for inputting numbers is selected from a menu (S200).

If the selected input mode is the English input mode and an English lower case is desired to be inputted in the English input mode, lower case letter buttons are inputted without activating the text converter. However, if upper case letters are to be inputted, a corresponding lower case button is inputted while pressing the conversion key or touching the contact sensing part (S202-S208).

Namely, in the steps S205 and S208, if text conversion is to be performed (namely, conversion from the upper case input to the lower case input or from the lower case input to the upper case input), the corresponding keys can be inputted while pressing the conversion key or touching the contact sensing part. In the steps S206 and S208, in case of a conversion between upper case and lower case letters (but not changing between other modes such characters or numbers), the process is returned to the step S214. In case of a conversion to the character or number input mode, the process is returned to the step S202 and a desired input mode is selected (S210).

Inputting of the lower case and upper case can be performed for English alphabet letters, but the technical features of the present disclosure can be applied for different languages of each country.

When a mode for inputting a number of a symbol is selected in the step S200 or when a mode conversion is performed to input a number or symbol in the step S210, the terminal changes a corresponding mode, and when a number is desired to be inputted in the mode-changed state, the desired number is inputted while not pressing the key or the contact sensing part for converting the number into a symbol. If a symbol is desired to be inputted, a corresponding desired number is selected from the symbols displayed on the keypad while pressing the conversion key or the contact sensing part and then inputted (S212-S218). The number and the symbol can be inputted through the same key, for which they are printed on the corresponding key of the keypad.

In the steps S216 and S218, if the inputting is intended to be reversely performed (namely, conversion from the symbol input to the number input or from the number input to the symbol input), the corresponding keys can be inputted while pressing the conversion key or the contact sensing part. In the steps S216 and S218, in case of a conversion to the symbol or number, not to a different mode such as English, the process is returned to the step S214, and in case of a conversion to the English input mode, the process is returned to the step S202 and a desired input mode is selected (S210).

As shown in FIG. 5, the present disclosure is not limited to the English language, and a number input mode conversion but can be applied to a field where the technical features can be implemented or performed such as the single consonant/double consonants conversion in Korean language.

When inputting of characters such as English or numbers is completed through the steps S200 to S220, the character input mode is terminated (S222).

As so far described, when the keys or the contact sensing parts are simultaneously pressed, key values are recognized by dividing such that whether each key has been pressed or released, so it can be determined which key was pressed which key has been pressed or which key has been released although several keys are simultaneously pressed. Consequently, in the English mode, the upper case/lower case can be changed and numbers of symbols can be inputted by using the certain key, rather than changing and inputting upper case/lower case characters by changing the mode by pressing the menu key several times.

The present disclosure provides a mobile terminal comprising: a keypad to allow a user to enter text in a particular text input mode; and an input mode converter to allow the user to enter text in a different text input mode via the keypad while the input mode converter is being activated by the user.

The keypad may be implemented in a virtual or non-virtual manner. The input mode converter may be a button or a touch-sensitive element that is separate from the keypad and that activates the different text input mode when being continuously depressed or continuously touched by the user. The button or the touch-sensitive element may be located opposite or adjacent to the planar surface of the keypad. The button or touch sensitive element may be mounted on at least one of a rear surface and a side edge of the mobile terminal. The keypad and the button or the keypad and the touch-sensitive element may be located in relatively close proximity to allow one-handed text entering by the user.

Also, the present disclosure provides a method of text inputting comprising: receiving text entries from a user via a keypad in a particular text input mode; activating a different text input mode via a text input mode converter operated by the user; and receiving text entries from the user via the keypad in the different text input mode while the text input mode converter is being depressed or continuously touched by the user.

The method may further comprise: de-activating the different text input mode when the user releases the depressed or touched text input mode converter. The activating and de-activating may be performed upon detecting changes in at least one of pressure, light, capacitance, and resistance due to a finger touch applied by the user.

As the features of the present disclosure may be embodied in several forms, it should also be understood that the above-described embodiments are not limited by any of the details of the foregoing description, unless otherwise specified, but rather should be construed broadly within its scope as defined in the appended claims. Therefore, all changes and modifications that fall within the metes and bounds of the claims, or equivalents of such metes and bounds are thus intended to be embraced by the appended claims.

What is claimed is:

1. A mobile terminal comprising:
a keypad part which includes a plurality of keys;
an input mode converting unit that changes an input mode of a key; and
a controller that changes an input code allocated to a keypad according to whether the shift key is inputted or not.

2. The terminal of claim 1, further comprising:
a memory that stores a command inputted form the keypad and the shift key input unit.

3. The terminal of claim 1, wherein, as for the changed input code, when a command is inputted from the input mode converting unit and a certain key is inputted from the keypad part in an English input mode, a lower case corresponding to the inputted key is changed to an upper case or an upper case is changed to a lower case.

4. The terminal of claim 1, wherein, as for the changed input code, when a command is inputted from the input mode converting unit and a certain key is inputted from the keypad part in a Hangul character input mode, Hangul single consonant corresponding to the inputted key is changed to Hangul double consonants or Hangul double consonants are changed to a Hangul single consonant.

5. The terminal of claim 1, wherein, as for the changed input code, when a command is inputted form the input mode converting unit and a certain key is inputted from the keypad part in a number input mode, a number corresponding to the inputted key is changed to a symbol or a symbol is changed to a number.

6. The terminal of claim 1, wherein the controller controls changing of the input code of characters allocated to each key of the keypad part.

7. The terminal of claim 1, wherein the input mode converting unit is provided at an upper, left or right portion of a front surface of the terminal or on a rear surface of the terminal.

8. The terminal of claim 7, wherein the input mode converting unit provided at the upper portion or on the rear surface of the terminal is provided at left and right portions.

9. The terminal of claim 8, wherein when the keys positioned on the left and right portions are simultaneously inputted, it is changed to an input mode of Hangul, English and number.

10. The terminal of claim 1, wherein the input mode converting unit changes the input mode by sensing light, temperature and pressure when it is touched by user's finger.

11. The terminal of claim 1, wherein the input mode converting unit comprises a direction key and a side key provided on the terminal.

12. The terminal of claim 1, wherein the controller controls displaying of a character, a number or a symbol corresponding to the changed input code.

13. A method for inputting characters of a mobile terminal comprising:
inputting a certain key of a keypad in a state that a first key is inputted;
controlling changing of an input code of the keypad key by analyzing and/or combining a command of the first key and a command of the inputted certain key of the keypad; and
displaying a character, a number or a symbol corresponding to the changed input code.

14. The method of claim 13, wherein, as for the changed input code, when a command of the first key is inputted and a certain key is inputted from the keypad part in a Hangul input mode, a single consonant corresponding to the inputted certain key is changed to double consonants or double consonants are changed to a single consonant.

15. The method of claim 13, wherein, as for the changed input code, when a command of the first key is inputted and a certain key is inputted in an English character input mode, English lower case corresponding to the inputted certain key is changed to an English upper case or an English upper case is changed to an English lower case.

16. The method of claim 13, wherein, as for the changed input code, when a command of the first key is inputted and a certain key is inputted in a number input mode, a number corresponding to the inputted certain key is changed to a symbol or a symbol is changed to a number.

17. The method of claim 13, wherein the first key is provided at an upper, left or right portion of a front surface of the terminal or on a rear surface of the terminal.

18. The method of claim 17, wherein the first key provided at the upper portion or on the rear surface of the terminal is provided at left and right portions.

19. The method of claim 18, wherein when the keys positioned on the left and right portions are simultaneously inputted, it is changed to an input mode of Hangul, English and number.

20. The method of claim 13, wherein an input mode converting unit changes the input mode by sensing light, temperature and pressure when it is touched by user's finger.

21. The method of claim 13, wherein an input mode converting unit comprises a direction key and a side key provided on the terminal.

22. A mobile terminal comprising:
a keypad to allow a user to enter text in a particular text input mode; and
an input mode converter to allow the user to enter text in a different text input mode via the keypad while the input mode converter is being activated by the user.

23. The terminal of claim 22, wherein the keypad is implemented in a virtual or non-virtual manner.

24. The terminal of claim 23, wherein the input mode converter is a button or a touch-sensitive element that is separate from the keypad and that activates the different text input mode when being continuously depressed or continuously touched by the user.

25. The terminal of claim 24, wherein the button or the touch-sensitive element is located opposite or adjacent to the planar surface of the keypad.

26. The terminal of claim 25 wherein the button or touch sensitive element is mounted on at least one of a rear surface and a side edge of the mobile terminal.

27. The terminal of claim 26, wherein the keypad and the button or the keypad and the touch-sensitive element are located in relatively close proximity to allow one-handed text entering by the user.

28. A method of text inputting comprising:
receiving text entries from a user via a keypad in a particular text input mode;
activating a different text input mode via a text input mode converter operated by the user; and
receiving text entries from the user via the keypad in the different text input mode while the text input mode converter is being depressed or continuously touched by the user.

29. The method of claim 28, further comprising
de-activating the different text input mode when the user releases the depressed or touched text input mode converter.

30. The method of claim 29, wherein the activating and de-activating are performed upon detecting changes in at least one of pressure, light, capacitance, and resistance due to a finger touch applied by the user.
